(19) United States
(12) Patent Application Publication
(10) Pub. No.: US 2021/0162625 A1
(43) Pub. Date: Jun. 3, 2021

(54) EXTRUSION APPARATUS FOR CERAMIC STRUCTURES AND HONEYCOMB FILTERS

(71) Applicant: CORNING INCORPORATED, Corning, NY (US)

(72) Inventor: Conor James Walsh, Campbell, NY (US)

(21) Appl. No.: 17/263,233

(22) PCT Filed: Jul. 11, 2019
(86) PCT No.: PCT/US2019/041408

§ 371 Date: Jan. 26, 2021

Related U.S. Application Data
(60) Provisional application No. 62/711,914, filed on Jul. 30, 2018.

(51) Int. Cl. B28B 3/22; B29C 48/00; B29C 48/40; B29C 48/515; B29C 48/80; B29C 48/85

(52) U.S. Cl. CPC B28B 3/222; B28B 3/224; B28B 3/226; B29C 48/022; B29L 2031/14; B29C 48/515; B29C 48/834; B29C 48/85; B29C 48/402

(57) ABSTRACT

An extruder that includes: an extruder barrel with an inlet end and a discharge end; a rotatable screw element disposed axially within the barrel with a screw inlet end proximate the inlet end and a screw discharge end proximate the discharge end of the barrel; a shaft extending axially through the screw element and comprising a central bore with an opening proximate to the inlet end of the barrel and extending through the shaft to a closed terminal end; and a coolant delivery conduit extending axially within the bore comprising a coolant inlet end proximate to the inlet end of the barrel and a coolant discharge end. The closed terminal end of the bore is located at a predetermined distance upstream from the screw discharge end. Further, the coolant discharge end is located within the bore and proximate to the closed terminal end of the bore.

This application claims the benefit of priority under 35 U.S.C. § 119 of U.S. Provisional Patent Application No. 62/711,914 filed on Jul. 30, 2018, the content of which is incorporated herein by reference in its entirety.

### FIELD OF THE DISCLOSURE

The present disclosure is in the field of manufacturing technical ceramic structures, and particularly relates to improved extrusion apparatus and methods for the manufacture of ceramic honeycomb filters that are useful for the treatment of exhaust gases from combustion sources.

### BACKGROUND

Various conventional approaches and apparatus have been employed in the fabrication of ceramic honeycomb structures by the process of plasticizing ceramic powder batch mixtures, extruding mixtures through honeycomb extrusion dies to form honeycomb extrudate, and drying and firing the extrudate to produce ceramic honeycombs of high strength and good thermal durability. The ceramic honeycombs thus produced are widely used as ceramic catalyst supports in motor vehicle exhaust systems. Honeycombs are also used as catalyst supports and wall-flow particulate filters for the removal of soot and other particulates from diesel and gas combustion engine exhausts.

### SUMMARY OF THE DISCLOSURE

According to some aspects of the present disclosure, an extruder for extruding ceramic structures is provided that includes: an extruder barrel for conveying a powder mixture, the barrel comprising an inlet end and a discharge end; a rotatable screw element disposed axially within the extruder barrel, the screw element comprising a screw inlet end proximate the inlet end of the barrel and a screw discharge end proximate the discharge end of the barrel; a shaft extending axially through the screw element that comprises a central bore, the bore comprising an opening proximate to the inlet end of the extruder barrel and extending through the shaft to a closed terminal end; and a coolant delivery conduit extending axially within the central bore comprising a coolant inlet end proximate to the inlet end of the extruder barrel and a coolant discharge end. The closed terminal end of the central bore is located at a predetermined distance upstream from the screw discharge end. Further, the coolant discharge end is located within the bore and proximate to the closed terminal end of the central bore.

According to some aspects of the present disclosure, an extruder for extruding ceramic structures is provided that includes: an extruder barrel for conveying a powder mixture, the barrel comprising an inlet end and a discharge end; a rotatable screw element disposed axially within the extruder barrel, the screw element comprising a screw inlet end proximate the inlet end of the barrel and a screw discharge end proximate the discharge end of the barrel; a shaft extending axially through the screw element that comprises a central bore, the bore comprising an opening proximate to the inlet end of the extruder barrel and extending through the shaft to a closed terminal end; and a coolant delivery conduit extending axially within the central bore comprising a coolant inlet end proximate to the inlet end of the extruder barrel and a coolant discharge end. The closed terminal end of the central bore is located at a predetermined distance upstream from the screw discharge end. Further, the coolant discharge end is located within the bore and proximate to the closed terminal end of the central bore. In addition, the rotatable screw element comprises a plurality of screw segments, and at least one of the screw segments has a thermal conductivity that differs from the thermal conductivity of the other screw elements.

According to some aspects of the present disclosure, an extruder for extruding ceramic structures is provided that includes: an extruder barrel for conveying a powder mixture, the barrel comprising an inlet end and a discharge end; a rotatable screw element disposed axially within the extruder barrel, the screw element comprising a screw inlet end proximate the inlet end of the barrel and a screw discharge end proximate the discharge end of the barrel; a shaft extending axially through the screw element that comprises a central bore, the bore comprising an opening proximate to the inlet end of the extruder barrel and extending through the shaft to a closed terminal end; and a coolant delivery conduit extending axially within the central bore comprising a coolant inlet end proximate to the inlet end of the extruder barrel and a coolant discharge end. The coolant discharge end is located within the bore and proximate to the closed terminal end of the central bore. In addition, the rotatable screw element comprises a plurality of screw segments, and at least one of the screw segments has a thermal conductivity that differs from the thermal conductivity of the other screw elements.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description describe various embodiments and are intended to provide an overview or framework to understanding the nature and character of the claimed subject matter.

The accompanying drawings are included to provide a further understanding of the various embodiments, and are incorporated into and constitute a part of this specification. The drawings illustrate the various embodiments described herein, and together with the description serve to explain the principles and operation of the claimed subject matter.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a schematic view of a barrel section of a twin-screw extruder for extruding ceramic structures, according to an embodiment;

FIG. 1A is an enlarged view of a portion of the barrel section of one of the screws of the extruder depicted in FIG. 1, according to an embodiment;

FIG. 1B is an enlarged view of a portion of the barrel section of one of the screws of the extruder depicted in FIG. 1, according to another embodiment;

FIG. 1C is an enlarged view of a portion of the barrel section of one of the screws of the extruder depicted in FIG. 1, according to a further embodiment;

FIG. 2 is a series of thermal images of extrudate as it exits an extruder configured with a coolant delivery conduit in the shaft of each screw, as processed according to various screw rate conditions, according to an embodiment; and

FIG. 3 is a series of thermal images of extrudate as it exits an extruder configured with a coolant delivery conduit in the shaft of each screw, as processed according to various screw element rotational rates and coolant delivery conditions, according to an embodiment.

Cylindrical honeycomb shapes having cross-sectional diameters measured transversely to the cylinder axis and direction of honeycomb channel orientation can range from as small as 5 cm up to 50 cm or more.

The foregoing summary, as well as the following detailed description of certain inventive techniques, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

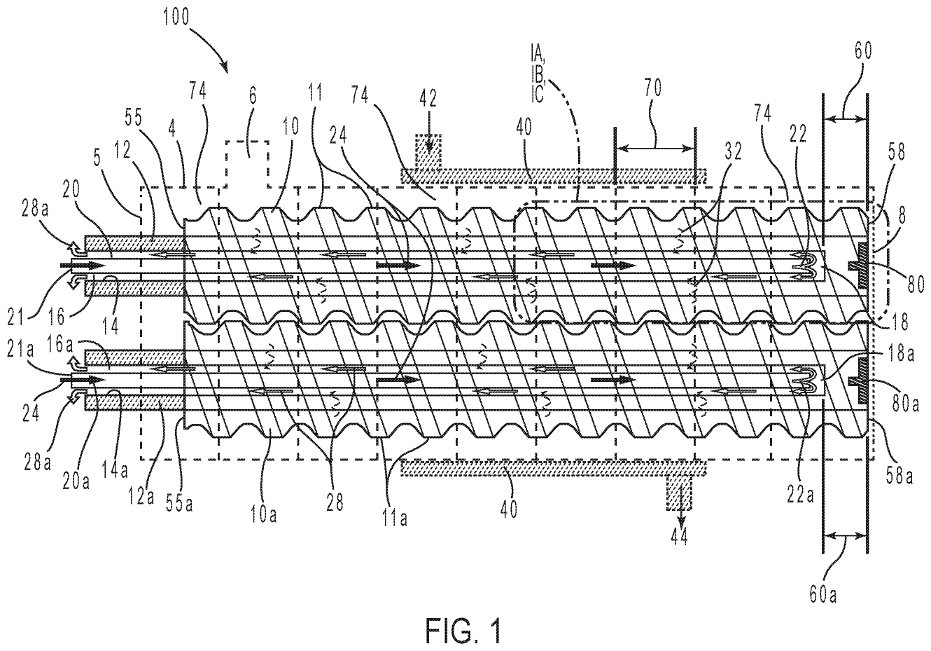

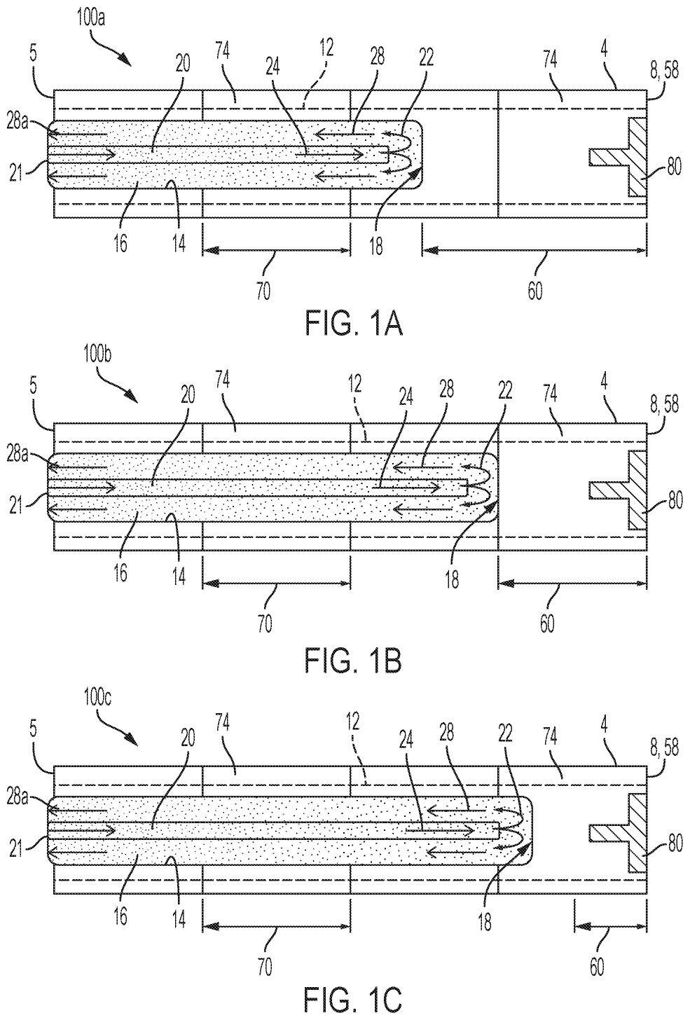

Referring to the drawings in general and to FIG. 1, in particular, it will be understood that the illustrations are for the purpose of describing particular embodiments and are not intended to limit the disclosure appended claims thereto. The drawings are not necessarily to scale, and certain features and certain views of the drawings may be shown exaggerated in scale or in schematic form in the interest of clarity and conciseness.

The methods and apparatus described in this disclosure are generally applicable to the production of any of a number of complex ceramic shapes via the plasticization and extrusion of inorganic powder-filled mixtures from screw extruders operated in modes where high core temperatures are a problem. However, embodiments of the disclosure are particularly useful for the management of thermal gradients that can arise during the processing of ceramic powder mixtures through rotating screw extruders (e.g., twin-screw extruders), especially large-diameter honeycomb structures and honeycomb structures of various diameters in high manufacturing volumes (e.g., at high throughputs). Accordingly, the descriptions that follow are presented with specific reference to such extrusion even though the utility of the disclosure is not otherwise limited to such honeycomb structures.

As noted earlier, the extraction of heat from the charges of plasticized ceramic mixtures being processed through extruders can prevent frictional overheating of the mixtures during the course of mixing and plasticization. The use of extruder cooling systems (e.g., as a heat-exchange jacket for the extruder barrel and/or a full-length, heat-exchange conduit for the extruder shaft) to prevent such overheating, however, can foster the development of substantial thermal gradients within the extruder barrel that can make it more difficult to maintain uniform extrusion rates across the diameters of the honeycomb extrudates. Honeycomb extrudate formed by the extrusion of plasticized ceramic powder mixtures under conditions where large core-to-periphery temperature gradients exist can exhibit a high degree of deformation or disruption of the honeycomb channel structure, or even fracturing of the extrudate, in the course of extrusion from a honeycomb extrusion die. Such disruption is particularly evident over a broad central region of the extrudate, and is caused by the fast flow of the heated core material through the die. Other approaches employing substantial reductions in screw speed and/or mixture throughputs have been employed to improve the management of these temperature gradients, but resulting in throughput levels that cannot support economically feasible operations for the manufacture of ceramic honeycomb structures.

The embodiments of the apparatus and methods of the disclosure offer much greater flexibility in managing this temperature uniformity problem. In particular, the extrusion apparatus and methods of the disclosure employ extrusion shaft coolant conduits with terminal ends that reside at a predetermined distance upstream from the discharge end of the screw shaft. Some extruders and methods of the disclosure accomplish similar cooling effects through the use of rotatable screw elements with screw segments having differing thermal conductivity values. Additional extruder and method embodiments employ a combination of these features to better manage the plasticized powder mixture temperature uniformity problems outlined earlier.

These extruders and methods offer advantages and benefits over conventional extrusion apparatus and methods. For example, the extrudate produced according to the apparatus and methods of the disclosure is believed to exhibit a reduced temperature gradient in the radial direction, which should result in end product honeycomb structures with lower percentages of defects. As another example, the improved temperature uniformity associated with the extrudate is expected to result in improved shape characteristics for the resulting honeycomb structures (e.g., roundness). Still further, the improved temperature uniformity associated with the extrudate produced according to the apparatus and methods of the disclosure can be leveraged to increase manufacturing throughput, without sacrificing yield.

Referring now to FIG. 1, an extruder 100 is depicted, as configured with two co-rotating screw elements 10 and 10a and generally indicated by the extruder barrel 4 (shown as an outline). Note that other configurations of the extruder 100 can employ a single screw element or more than two screw elements (not shown). As shown in FIG. 1, the extruder barrel 4 is for conveying the ceramic powder mixture and includes a barrel inlet end 5, a barrel inlet 6 and a barrel discharge end 8. Referring more particularly to FIG. 1, the co-rotating screw elements 10 and 10a are disposed axially within the extruder barrel 4 and include bored shafts 12 and 12a, with each of the bored shafts 12 and 12a being provided with bores 14 and 14a, respectively. The co-rotating screws 10 and 10a include screw inlet ends 55, 55a proximate the barrel inlet end 5, and discharge ends 58, 58a proximate the barrel discharge end 8, respectively. In addition, each of the discharge ends 58, 58a include a respective screw bolt 80, 80a configured to secure the rotating screw elements 10 and 10a with an appropriate axial force (e.g., to secure any segments that make up the screw elements 10, 10a together). Further, the shafts 12, 12a each extend axially through the respective screw elements 10, 10a, as depicted in exemplary form in FIG. 1. With regard to the bores 14, 14a, each includes an opening 16 or 16a proximate the barrel inlet end 5 and extending through the shafts 12 or 12a to a closed terminal end 18 or 18a, respectively.

Referring again to FIG. 1, the extruder 100 further includes a coolant delivery conduit 20, 20a that extends axially within the respective bores 14, 14a. The coolant delivery conduits 20, 20a each include a coolant inlet end 21, 21a, respectively, that is generally proximate to the extruder inlet end 5. The coolant delivery conduits 20, 20a also each include a coolant discharge end 22, 22a located in proximity to the closed terminal ends 18, 18a of the bores 14, 14a, respectively. Notably, the coolant discharge ends 22, 22a are situated at a setoff from the closed terminal ends 18, 18a to ensure that coolant 24 can flow from the ends 18, 18a (e.g., without any substantial reduction in flow rate) and return back through the conduits 20, 20a toward the inlet ends 21, 21a, as shown in FIG. 1.

Referring again to the extruder 100 depicted in FIG. 1, in the course of mixing and plasticizing a ceramic powder mixture that is input to an extruder barrel 4 at the extruder barrel input 6, frictional heating of the mixture occurs by action of the rotatable screw elements 10 and 10a. In embodiments, the rotatable screw elements 10, 10a can be rotated at a screw element rotational rate (“SRR”) from about 5 rpm to about 100 rpm. For example, the screw elements 10, 10a can be rotated at an SRR of 5 rpm, 10 rpm, 15 rpm, 20 rpm, 25 rpm, 30 rpm, 35 rpm, 40 rpm, 45 rpm, 50 rpm, 55 rpm, 60 rpm, 65 rpm, 70 rpm, 75 rpm, 80 rpm, 85 rpm, 90 rpm, 95 rpm, 100 rpm, and all SRR values between these levels. More particularly, the frictional heating begins near the extruder barrel inlet 6 and continues throughout the mixing process such that peak core temperatures are reached in the mixture at points proximate to the extruder discharge end 8. Managing these temperatures within the mixture is in accordance with methods and apparatus of the disclosure. In particular, a fluid coolant is introduced into the conduit inlet ends 21, 21a in each of the respective coolant delivery conduits 20, 20a and transported through those conduits toward the conduit discharge ends 22, 22a. Further, the direction of the coolant transport from the inlet ends 21, 21a is indicated by the hatched arrows 24. In embodiments, the delivery conduits 20, 20a are configured to transport coolant at a rate that ranges from about 0 gpm to about 40 gpm. For example the delivery conduits 20, 20a can transport coolant at a flow rate of 0 gpm, 5 gpm, 10 gpm, 15 gpm, 20 gpm, 25 gpm, 30 gpm, 35 gpm, 40 gpm, and all coolant flow rates between these levels.

Still referring to the extruder 100 depicted in FIG. 1, the cold coolant within the coolant delivery conduits 20, 20a is finally delivered into the central bores 14, 14a at the closed terminal ends 18, 18a of the bores as indicated by the arrows at the conduit discharge ends 22, 22a. The coolant is then carried back through the bores 14, 14a via the annular channels formed between the coolant delivery conduits 20, 20a and the bore walls. The direction of coolant out-flow along the walls of the bores 14 and 14a is indicated by open arrows, such as arrows 28 disposed in these annular channels. Heat extraction via the out-flowing coolant, from both rotatable screw elements 10 and 10a and the plasticized ceramic powder in contact with the screw elements, is indicated by wavy arrows such as arrows 32 shown in FIG. 1. Finally, the thus-heated coolant is discharged from the bores 14, 14a of the shafts 12, 12a through the annular spaces at bore openings 16, 16a, as indicated by coolant discharge arrows 28a.

Referring again to the extruder 100 depicted in FIG. 1, its coolant delivery conduits 20, 20a beneficially manage the temperature uniformity of the ceramic powder mixture as it moves axially along the screw elements 10, 10a. As noted earlier, the temperature of the ceramic powder mixture tends to increase as it moves axially from the extruder barrel inlet 6 to the extruder barrel discharge end 8, whereas the cooling benefit afforded by the coolant delivery conduits 20, 20a is maximum at the closed terminal end 18, 18a of the bores 14, 14a and decreases toward extruder barrel inlet 6 because the coolant out-flow direction is opposite that of the ceramic powder mixture. Accordingly, the extruder 100 benefits from its coolant delivery conduit 20, 20a configuration that affords maximum cooling in the region of the screw elements 10, 10a where the ceramic powder mixture can reach its maximum temperature from frictional heating, i.e., proximate to the closed terminal end 18, 18a of the bores 14, 14a and the barrel discharge end 8.

While the coolant delivery conduit 20, 20a configuration within the extruder 100 certainly provides a benefit in managing the temperature uniformity of the ceramic powder mixture as it leaves the extruder barrel discharge end 8, in practice, significant radial temperature gradients can exist in the ceramic powder mixture in proximity to the closed terminal end 18, 18a of the coolant delivery conduits 20, 20a. Without being bound by theory, it is believed that localized temperature differentials can be developed in the ceramic powder mixture in the screw elements 10, 10a in proximity to the closed terminal end 18, 18a of the coolant delivery conduits 20, 20a. In particular, these differentials can develop as the relatively hot ceramic powder mixture (from frictional heating along the screw elements 10, 10a) comes into contact with the shafts 12, 12a in close proximity to the closed terminal end 18, 18a, where the coolant is at its lowest temperature.

Mindful of these additional thermal considerations, the extruder 100 depicted in FIG. 1 is particularly configured to maximize the temperature uniformity of the ceramic powder mixture as it leaves the extruder barrel discharge end 8. Notably, the coolant delivery conduit 20, 20a is configured such that the closed terminal end 18, 18a is located at a predetermined distance 60, 60a that is upstream from the screw discharge end 58, 58a and extruder barrel discharge end 8. Further, the predetermined distance 60, 60a must be of a sufficient length to ensure that the close terminal end 18, 18a is spaced from the screw bolts 80, 80a, e.g., spaced at least 25 mm, at least 50 mm, or more from the upstream end of the screw bolts 80, 80a. Advantageously, the predetermined distance 60, 60a ensures that any localized temperature differential that develops in the ceramic powder mixture in close proximity to the closed terminal end 18, 18a of the coolant delivery conduits 20, 20a is reduced or otherwise eliminated as the mixture moves axially toward the screw discharge end 58, 58a and extruder barrel discharge end 8. Principally, the coolant delivery conduit 20, 20a does not extend into the region of the rotatable screw elements 10, 10a defined by the predetermined distance 60, 60a. As a result, any localized temperature differentials that exist in the ceramic powder mixture are effectively washed out by the continued mixing and plasticizing of the mixture that occurs along the portion of the screw elements 10, 10a that is not directly cooled by the coolant delivery conduits 20, 20a. In addition, the predetermined distance 60, 60a can be set at an optimal length to increase the amount of temperature washing without leading to an excessive increase in temperature to the mixture from further frictional heating without direct cooling from the coolant conduits 20, 20a. As a result, the extruder 100 is configured to optimize the degree of temperature uniformity in the ceramic powder mixture as it exits the extruder barrel discharge end 8 and screw discharge end 58, 58a.

According to some embodiments, the extruder 100 depicted in FIG. 1 can be configured to include additional cooling apparatus on the exterior of the extruder barrel 4 to further manage the temperature uniformity of the ceramic powder mixture. In particular, the extruder 100 can include a cooling jacket 40 arranged about the extruder barrel 4, as shown in FIG. 1. A coolant for circulation through the jacket 40 can be introduced through the jacket inlet 42, and discharged from the jacket outlet 44 after extracting heat from the extruder barrel 4. Additional control over the thermal profile in the ceramic powder mixture can be provided if the temperatures of the coolant introduced into the coolant jacket 40 and the coolant delivery conduits 20, 20a are independently controlled, such as by separate heat extraction controllers and thermocouples (not shown).

Referring again to FIG. 1, the extruder 100 can include an extruder barrel 4 that comprises a plurality of barrel segments 74, each segment having a length 70. In embodiments, the segments 74 each possess the same length 70. In other implementations, some or all of the segments 74 possess lengths 70 that differ from one another. Each barrel segment, for example, can range from about 100 mm to about 1000 mm in length, including but not limited to segment lengths of 240 mm, 360 mm, 480 mm, 510 mm and 720 mm. According to some embodiments, the extruder barrel 4 includes at least two barrel segments 74. Accordingly, the extruder barrel 4 can include 2, 3, 4, 5, 6, 7, 8, 9, 10, 15, 20, 25, 30 and even more barrel segments 74, including all quantities of segments 74 between these values.

Referring to FIG. 1A, an extruder 100a is depicted that is substantially similar in nature to the extruder 100 depicted in FIG. 1. Accordingly, the like-numbered elements associated with extruder 100a and 100 depicted in FIGS. 1, 1A have the same or substantially similar structure and functions. More particularly, the extruder 100a includes an extruder barrel 4 that comprises a plurality of extruder barrel segments 74 and a coolant delivery conduit 20 (along with an additional coolant delivery conduit 20a in configurations with twin screw elements 10, 10a, as shown in FIG. 1) such that the predetermined distance 60 is about the same length as the length 70 of the last extruder barrel segment 74 or greater, the last segment being defined in part by the extruder discharge end 8 and screw discharge end 58, as shown in FIG. 1A. In some embodiments, the predetermined distance 60 is within 25%, 20%, 15%, 10%, 5% or any percentage between these levels of the length 70 of the last extruder barrel segment 74. Accordingly, in some embodiments, the predetermined distance 60 can range from about 75 mm to 1250 mm, depending on the length 70 of the last extruder barrel segment 74. As also shown in FIG. 1A, the predetermined distance 60 is set such that the discharge end 8 is spaced from the upstream end of the screw bolt 80. Depending on the throughput of the ceramic powder mixture and its composition, the configuration of the extruder 100a can be advantageous in ensuring that any temperature differential introduced by virtue of the coolant delivery conduit 20 is washed or otherwise removed given the overall length of the predetermined distance 60 in the extruder 100a. As also shown in FIG. 1A, embodiments of the extruder 100a can be configured such that the last barrel segment 74 (i.e., the segment 74 at the screw discharge end 58 and extruder barrel discharge end 8 shown in FIG. 1A) is configured to convey the ceramic powder mixture without direct conductive cooling from the coolant delivery conduit 20.

Turning now to FIG. 1B, an extruder 100b is depicted that is substantially similar in nature to the extruder 100 depicted in FIG. 1. Accordingly, the like-numbered elements associated with extruder 100b and 100 depicted in FIGS. 1, 1B have the same or substantially similar structure and functions. More particularly, the extruder 100b includes an extruder barrel 4 that comprises a plurality of extruder barrel segments 74 and a coolant delivery conduit 20 such that the predetermined distance 60 is greater than the length 70 of the last extruder barrel segment 74, the last segment being defined in part by the extruder discharge end 8 and screw discharge end 58 as shown in FIG. 1B. In some embodiments, the predetermined distance 60 is from 100% to about 200% of the length 70 of the last extruder barrel segment 74. Accordingly, in some embodiments, the predetermined distance 60 can range from about 100 mm to 2000 mm, depending on the length 70 of the last extruder barrel segment 74. As also shown in FIG. 1B, the predetermined distance 60 is set such that the discharge end 8 is spaced from the upstream end of the screw bolt 80. Depending on the throughput of the ceramic powder mixture and its composition, the configuration of the extruder 100b can be particularly advantageous in ensuring that any temperature differential introduced by virtue of the coolant delivery conduit 20 is washed or otherwise removed given the substantial overall length of the predetermined distance 60 in the extruder 100b. As also shown in FIG. 1B, embodiments of the extruder 100b can be configured such that the last barrel segment 74 (i.e., the segment 74 at the screw discharge end 58 and extruder barrel discharge end 8 shown in FIG. 1B) is configured to convey the ceramic powder mixture without direct conductive cooling from the coolant delivery conduit 20.

Referring now to FIG. 1C, an extruder 100c is depicted that is substantially similar in nature to the extruder 100 depicted in FIG. 1. Accordingly, the like-numbered elements associated with extruder 100c and 100 depicted in FIGS. 1, 1C have the same or substantially similar structure and functions. More particularly, the extruder 100c includes an extruder barrel 4 that comprises a plurality of extruder barrel segments 74 and a coolant delivery conduit 20 such that the predetermined distance 60 is less than the length 70 of the last extruder barrel segment 74, the last segment being defined in part by the extruder discharge end 8 and screw discharge end 58 as shown in FIG. 1C. In some embodiments, the predetermined distance 60 is about 5% to about 50% of the length 70 of the last extruder barrel segment 74. Accordingly, in some embodiments, the predetermined distance 60 can range from about 5 mm to 500 mm, depending on the length 70 of the last extruder barrel segment 74. As also shown in FIG. 1C, the predetermined distance 60 is set such that the discharge end 8 is spaced from the upstream end of the screw bolt 80. Depending on the throughput of the ceramic powder mixture and its composition, the configuration of the extruder 100c can be particularly advantageous in ensuring that any temperature differential introduced by virtue of the coolant delivery conduit 20 is washed or otherwise removed, while ensuring that the temperature of the ceramic powder mixture does not substantially increase through the frictional mixing of the mixture afforded by the portion of the screw element 10 (see FIG. 1, not shown in FIG. 1C) in the last barrel segment 74 that lacks any direct cooling from the cooling delivery conduit 20. As also shown in FIG. 1C, embodiments of the extruder 100c can be configured such that a portion of the last barrel segment 74 (i.e., the segment 74 at the screw discharge end 58 and extruder barrel discharge end 8 shown in FIG. 1C) is configured to convey the ceramic powder mixture without direct conductive cooling from the coolant delivery conduit 20.

With further regard to the extruders 100 depicted in FIG. 1 (and 100a-c depicted in FIGS. 1A-1C), control of the heat transfer from the coolant delivery conduits 20, 20a to the rotatable screw elements 10, 10a, and then to the ceramic powder mixture, can be of importance in some embodiments. To improve the heat transfer, the rate of flow of the coolant through the bores 14, 14a of the screw shafts 12, 12a should be high enough to initiate and maintain turbulent flow through the bores. The flow rates of the coolant can depend on the volumes of the bores 14, 14a and coolant delivery conduits 20, 20a provided in the extruder 100 and 100a-c being operated, as well as the types of surface discontinuities, if any, provided along the fluid flow paths within the bores 14, 14a to develop any turbulence desired to be generated in the coolant flow path. Flow rates sufficient to effect a complete exchange of the total volume of coolant occupying each of the bores 14, 14a within a time interval of from 0.25-2 minutes are generally suitable for ceramic powder mixtures contemplated by the disclosure. However, lower rates are useful, in some implementations, especially at higher coolant turbulence levels, and higher rates can be selected where additional cooling capacity is desired. Further, the fluid selected for use in the coolant delivery conduits 20, 20a may be chosen depending upon the design of the extruder 100 and 100a-c and the level of heat extraction required. Preferably, fluids having specific heat capacities of at least about 2 kJ/kg*° K, e.g., water or water with additives appropriate for use in water-based cooling systems, are normally effective. The use of a heat-conducting grease between the shafts 12, 12a and screw elements 10, 10a can be helpful, according to some embodiments, in further improving heat transfer from the plasticized ceramic powder mixture to the coolant.

Referring again to the extruders 100 depicted in FIG. 1 (and 100a-c depicted in FIGS. 1A-1C), the rotatable screw elements 10, 10a and screw shafts 12, 12a should be fabricated from materials understood by those with ordinary skill in the field of the disclosure in view of their mechanical property and manufacturing requirements. For example, the materials of these components should be selected to ensure that the levels of torque and fatigue typically encountered in the use of screw extruders to process ceramic powder mixtures can be managed. For example, high tensile strength materials can be selected for the screw elements 10, 10a, e.g., steel or other shaft stock with a tensile strength of at least 2500 kg/cm². Further, materials with these properties can ensure that the screw shafts 12, 12a can be bored from the screw elements 10, 10a, as arranged according to the extruder 100 and 100a-c configurations depicted in FIGS. 1 and 1A-1C and described above.

Effective designs for the rotatable screw elements 10, 10a of the extruders 100 depicted in FIG. 1 (and 100a-c depicted in FIGS. 1A-1C) will also incorporate bore sizes (i.e., for the central bores 14, 14a) large enough to provide for adequate coolant flow but not so large as to compromise torque limits of the screw shafts 12, 12a. In general, the retained torque capacity of the screw shafts 12, 12a is at a maximum for shafts without bores. According to embodiments of the disclosure, the extruders 100 and 100a-c can be configured with screw shafts 12, 12a having central bores 14, 14a with diameters from about 5% to about 85% of the outer diameter of the shafts 12, 12a. In implementations of the extruders 100 and 100a-c, the diameters of the bores 14, 14a can be 5%, 10%, 15%, 20%, 25%, 30%, 35%, 40%, 45%, 50%, 55%, 60%, 65%, 70%, 75%, 80%, and 85% of the outer diameter of the shafts 12, 12a, including all bore diameters between these values.

Referring again to the rotatable screw elements 10, 10a of the extruders 100 depicted in FIG. 1 (and 100a-c depicted in FIGS. 1A-1C), thermal property considerations can drive the selection of the materials employed in these components, according to some embodiments of the disclosure. Notably, it is apparent that the cooling ability of the coolant flowing within the coolant delivery conduits 20, 20a is at a maximum at the terminal end 18, 18a of the bores 14, 14a and decreases as it moves toward the openings 16, 16a by virtue of being heated via conduction by the ceramic powder mixture as it moves in the opposite direction through the extruder barrel 4 over the screw elements 10, 10a. Conversely, the ceramic powder mixture can tend to increase in temperature from frictional effects from the screw elements 10, 10a as the mixture moves from the extruder barrel inlet 6 toward the extruder discharge end 8. As a result, temperature differentials, while certainly minimized by the configuration of the extruder 100 and 100a-c, can develop within the ceramic powder mixtures under certain conditions (e.g., high flow rates for the ceramic powder mixtures driven by manufacturing needs). With these considerations in mind, the thermal conductivity of the screw elements 10, 10a can be adjusted to further homogenize the temperatures within the ceramic powder mixture in the axial and radial directions within the extruder barrel 4.

In embodiments of the extruder 100 depicted in FIG. 1 (and 100a-c depicted in FIGS. 1A-1C), for example, the rotatable screw elements 10, 10a can comprise a plurality of screw segments 11, 11a as shown in FIG. 1. Further, at least one of the screw segments 11, 11a can be configured with a thermal conductivity that differs from the thermal conductivity of the other segments 11, 11a. Advantageously, the adjustment or varying of the thermal conductivity of the screw elements 10, 10a in the axial direction (e.g., by changing the thermal conductivity of the segments 11, 11a) can further serve to homogenize the cooling effect afforded by the coolant delivery conduits 20, 20a to the ceramic powder mixture as it flows through the extruder barrel 4. For example, one or more of the segments 11, 11a can be fabricated from materials having a lower thermal conductivity than that of typical of ferrous and no-ferrous steels, e.g., ceramic materials such as alumina, zirconia, silica, etc. As another example, all of the segments 11, 11a of the screw elements can be fabricated from a steel composition, while certain of the segments 11, 11a can be coated with a lower thermal conductivity material, e.g., a silica, zirconia or alumina coating. According to another embodiment, the foregoing principles can be employed in extruders 100 and 100a-c such that the screw segment 11 proximate the last barrel segment 74 (at the extruder discharge end 8) is configured with a lower thermal conductivity material than the other screw segments 11. Such a configuration can ensure that the ceramic powder mixture, as already homogenized in terms of temperature from conduction of the coolant flowing in the cooling delivery conduits 20, 20a as it approaches the discharge end 8, does not further cool and develop any additional temperature differentials from conductive cooling effects from the coolant at the terminal end 18, 18a of the conduits 20, 20a through the discharge end regions of the shafts 12, 12a that do not possess a central bore 14, 14a (see FIG. 1).

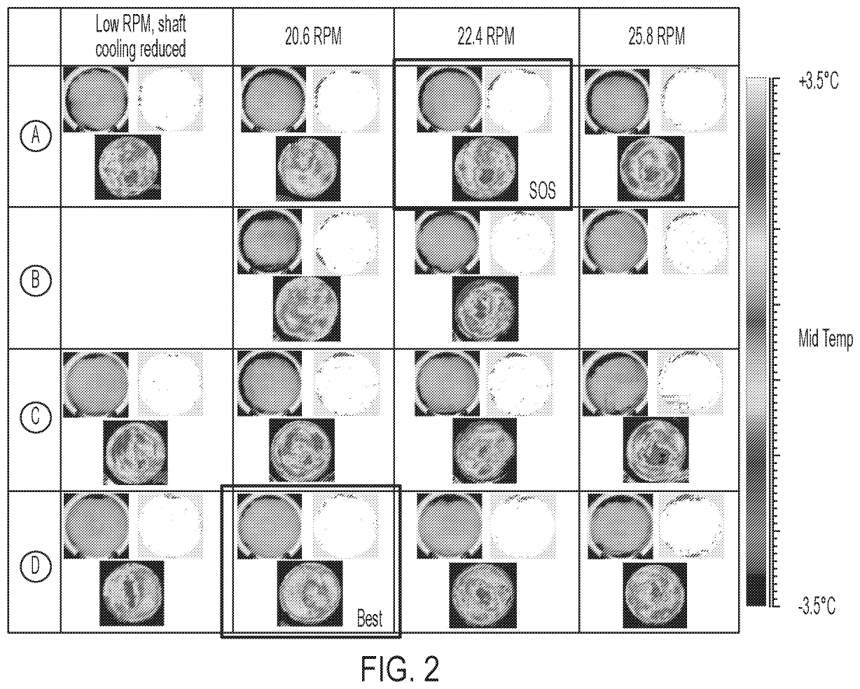

Referring now to FIG. 2, thermal images, shadow images and defect maps are provided of extrudate (ceramic powder mixture) as it exits an extruder configured with a coolant delivery conduit in the shaft of each screw element, as processed according to various screw element rate conditions, according to an embodiment. Note that the extruder employed to generate the images depicted in FIG. 2 employs a coolant delivery conduit in which the closed terminal end of the bore is located proximate the screw discharge end of the extruder (not at a predetermined distance from the end). As noted in the column headings, extrudate was prepared according to screw element rotational rates <<20 rpm, 20.6 rpm, 22.4 rpm and 25.8 rpm. As also noted in the row headings, extrudate was prepared with four extruder configurations having different screw element configurations (“A”, “B”, “C” and “D”). With regard to images presented in FIG. 2, it is evident that the screw configurations have a limited effect on temperature uniformity. Rather, it is evident that the screw rotational rates have a more significant effect on the temperature uniformity. In particular, the extrudate samples prepared with the highest screw element rotational rates (25.8 rpm) exhibited the highest temperature differentials, which may be indicative of inferior or unacceptable product. Conversely, it is evident that the extrudate samples prepared with the lowest screw element rotational rates (20.6 rpm) exhibited better temperature differentials, but some evidence of significant temperature gradients remains in most of the samples.

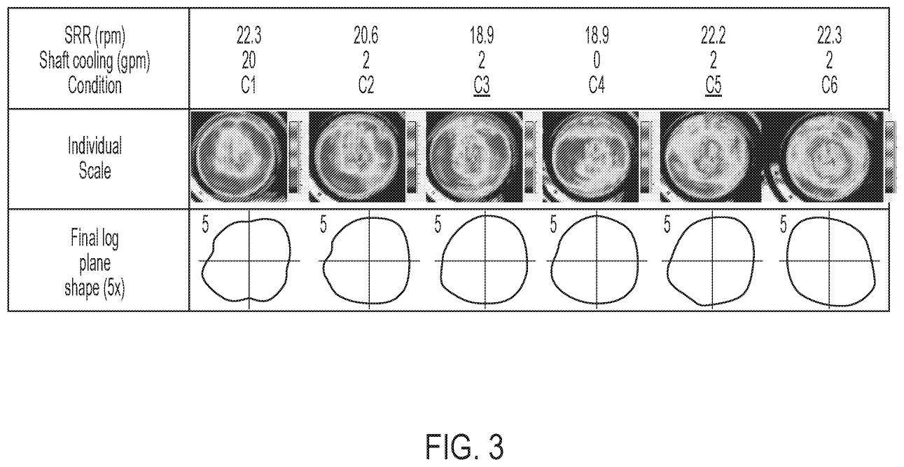

Referring now to FIG. 3, thermal images are provided of extrudate (ceramic powder mixture) as it exits an extruder configured with a coolant delivery conduit in the shaft of each screw element, as processed according to various conditions (“C1” to “C6”) given by the following extruder parameters: screw element rotational rate (“SRR”) in units of rpm, and “shaft cooling” in units of gpm. Note that the extruder employed to generate the images depicted in FIG. 3 employs a coolant delivery conduit in which the closed terminal end of the bore is located proximate the screw discharge end of the extruder (not at a predetermined distance from the end). As noted in the column headings, extrudate was prepared according to screw element rotational rates of 22.3 rpm, 20.6 rpm, 18.9 rpm, 22.2 rpm, and 22.3 rpm; and shaft coolant flow rates of 20 gpm, 2 gpm and 0 gpm. With regard to the images shown in FIG. 3, it is evident that the best extrudate samples were produced with low screw element rotational rates (e.g., screw rates of 18.9 rpm) and no shaft cooling (e.g., 0 gpm), i.e., the C4 condition. Conversely, the extrudate samples produced with undesirable levels of temperature non-uniformity are exemplified by higher screw element rotational rates (e.g., screw rates of 20.6 and 22.3 rpm) and higher shaft cooling rates (e.g., 2 and 20 gpm), e.g., the C1 and C2 conditions.

Accordingly, it is evident from FIG. 3 that an extruder that employs a coolant delivery conduit in which the closed terminal end of the bore is located proximate the screw discharge end of the extruder (not at a predetermined distance from the end) can produce extrudate with reasonably acceptable temperature uniformity, but at a cost of low manufacturability as evidenced by the best samples having low screw element rotational rates and/or limited coolant flow rates or no coolant flow. Nevertheless, it is believed that the extruders 100 and 100a-c of the disclosure depicted in FIGS. 1 and 1A-1C, each with a closed terminal end of the bore at a predetermined distance from the screw discharge end of the extruder, provide a configuration that can improve the temperature uniformity of extruded parts without sacrificing manufacturability (e.g., by maintaining high throughputs and coolant flow rates). Notably, the portion of the extruder that is not in contact with the coolant delivery conduit ensures that any temperature differential in the extrudate that develop from friction associated with relatively screw rotational rates and/or conductive cooling from higher flows within the coolant delivery conduit can be reduced or eliminated in this portion of the extruder.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

According to a first aspect, an extruder for extruding ceramic structures is provided that includes: an extruder barrel for conveying a powder mixture, the barrel comprising an inlet end and a discharge end; a rotatable screw element disposed axially within the extruder barrel, the screw element comprising a screw inlet end proximate the inlet end of the barrel and a screw discharge end proximate the discharge end of the barrel; a shaft extending axially through the screw element that comprises a central bore, the bore comprising an opening proximate to the inlet end of the extruder barrel and extending through the shaft to a closed terminal end; and a coolant delivery conduit extending axially within the central bore comprising a coolant inlet end proximate to the inlet end of the extruder barrel and a coolant discharge end. The closed terminal end of the central bore is located at a predetermined distance upstream from the screw discharge end. Further, the coolant discharge end is located within the bore and proximate to the closed terminal end of the central bore.

According to a second aspect, the first aspect is provided, wherein the extruder barrel comprises a plurality of barrel segments, the predetermined distance is at least the length of a barrel segment, and the last barrel segment is proximate the discharge end of the barrel

According to a third aspect, the second aspect is provided, wherein the plurality of barrel segments is at least nine barrel segments.

According to a fourth aspect, the third aspect is provided, wherein the rotatable screw element is a pair of co-rotating screw elements disposed axially within the extruder barrel.

According to a fifth aspect, the second aspect is provided, wherein the last barrel segment is configured for conveying the powder mixture without conductive cooling from the coolant delivery conduit.

According to a sixth aspect, the first aspect is provided, wherein the plurality of barrel segments is at least nine barrel segments.

According to a seventh aspect, the sixth aspect is provided, wherein the plurality of barrel segments is at least nine barrel segments.

According to an eighth aspect, an extruder for extruding ceramic structures is provided that includes: an extruder barrel for conveying a powder mixture, the barrel comprising an inlet end and a discharge end; a rotatable screw element disposed axially within the extruder barrel, the screw element comprising a screw inlet end proximate the inlet end of the barrel and a screw discharge end proximate the discharge end of the barrel; a shaft extending axially through the screw element that comprises a central bore, the bore comprising an opening proximate to the inlet end of the extruder barrel and extending through the shaft to a closed terminal end; and a coolant delivery conduit extending axially within the central bore comprising a coolant inlet end proximate to the inlet end of the extruder barrel and a coolant discharge end. The closed terminal end of the central bore is located at a predetermined distance upstream from the screw discharge end. Further, the coolant discharge end is located within the bore and proximate to the closed terminal end of the central bore. In addition, the rotatable screw element comprises a plurality of screw segments, and at least one of the screw segments has a thermal conductivity that differs from the thermal conductivity of the other screw elements.

According to a ninth aspect, the eight aspect is provided, wherein the extruder barrel comprises a plurality of barrel segments, the predetermined distance is at least the length of a barrel segment, and the last barrel segment is proximate the discharge end of the barrel.

According to a tenth aspect, the ninth aspect is provided, wherein the screw segment proximate the last barrel segment has a thermal conductivity less than the thermal conductivity of the other screw segments.

According to an eleventh aspect, the tenth aspect is provided, wherein the rotatable screw element is a pair of co-rotating screw elements disposed axially within the extruder barrel.

According to a twelfth aspect, the tenth aspect is provided, wherein the screw segment proximate the last barrel segment is fabricated from a ceramic material.

According to a thirteenth aspect, the ninth aspect is provided, wherein the last barrel segment and the screw segment proximate the last barrel segment are configured for conveying the powder mixture without conductive cooling from the coolant delivery conduit.

According to a fourteenth aspect, the eighth aspect is provided, wherein the extruder barrel comprises a plurality of barrel segments, the predetermined distance is less than the length of a barrel segment, and the last barrel segment is proximate the discharge end of the barrel.

According to a fifteenth aspect, the fourteenth aspect is provided, wherein the plurality of barrel segments is at least nine barrel segments.

According to a sixteenth aspect, an extruder for extruding ceramic structures is provided that includes: an extruder barrel for conveying a powder mixture, the barrel comprising an inlet end and a discharge end; a rotatable screw element disposed axially within the extruder barrel, the screw element comprising a screw inlet end proximate the inlet end of the barrel and a screw discharge end proximate the discharge end of the barrel; a shaft extending axially through the screw element that comprises a central bore, the bore comprising an opening proximate to the inlet end of the extruder barrel and extending through the shaft to a closed terminal end; and a coolant delivery conduit extending axially within the central bore comprising a coolant inlet end proximate to the inlet end of the extruder barrel and a coolant discharge end. The coolant discharge end is located within the bore and proximate to the closed terminal end of the central bore. In addition, the rotatable screw element comprises a plurality of screw segments, and at least one of the screw segments has a thermal conductivity that differs from the thermal conductivity of the other screw elements.

According to a seventeenth aspect, the sixteenth aspect is provided, wherein the extruder barrel comprises a plurality of barrel segments and the last barrel segment is proximate the discharge end of the barrel.

According to an eighteenth aspect, the seventeenth aspect is provided, wherein the screw segment proximate the last barrel segment has a thermal conductivity less than the thermal conductivity of the other screw segments.

According to a nineteenth aspect, the eighteenth aspect is provided, wherein the rotatable screw element is a pair of co-rotating screw elements disposed axially within the extruder barrel.

According to a twentieth aspect, the eighteenth aspect is provided, wherein the screw segment proximate the last barrel segment is fabricated from a ceramic material.

1. An extruder for extruding structures from a ceramic-forming mixture, the extruder comprising:
an extruder barrel for conveying the mixture, the barrel comprising an inlet end and a discharge end;
a rotatable screw element disposed axially within the extruder barrel, the screw element comprising a screw inlet end proximate the inlet end of the barrel and a screw discharge end proximate the discharge end of the barrel;
a shaft extending axially through the screw element , the shaft comprising a central bore, the bore comprising an opening proximate to the inlet end of the extruder barrel and extending through the shaft to a closed terminal end; and
a coolant delivery conduit extending axially within the central bore comprising a coolant inlet end proximate to the inlet end of the extruder barrel and a coolant discharge end,
wherein the closed terminal end of the central bore is located at a predetermined distance upstream from the screw discharge end, and
further wherein the coolant discharge end is located within the bore and proximate to the closed terminal end of the central bore
wherein the extruder barrel comprises a plurality of barrel segments, the predetermined distance is at least the length of a barrel segment, and the last barrel segment is proximate the discharge end of the barrel.

2. (canceled)

3. The extruder according to claim 1, wherein the plurality of barrel segments is at least nine barrel segments.

4. The extruder according to claim 3, wherein the rotatable screw element is a pair of co-rotating screw elements disposed axially within the extruder barrel.

5. The extruder according to claim 1, wherein the last barrel segment is configured for conveying the powder mixture without conductive cooling from the coolant delivery conduit.

6. The extruder according to claim 1, wherein the extruder barrel comprises a plurality of barrel segments, the predetermined distance is less than the length of a barrel segment, and the last barrel segment is proximate the discharge end of the barrel.

7. The extruder according to claim 6, wherein the plurality of barrel segments is at least nine barrel segments.

8. An extruder for extruding structures from a ceramic-forming mixture, the extruder comprising:
an extruder barrel for conveying the mixture, the barrel comprising an inlet end and a discharge end;
a rotatable screw element disposed axially within the extruder barrel, the screw element comprising a screw inlet end proximate the inlet end of the barrel and a screw discharge end proximate the discharge end of the barrel;
a shaft extending axially through the screw element that comprises a central bore, the bore comprising an opening proximate to the inlet end of the extruder barrel and extending through the shaft to a closed terminal end; and
a coolant delivery conduit extending axially within the central bore comprising a coolant inlet end proximate to the inlet end of the extruder barrel and a coolant discharge end, wherein the closed terminal end of the central bore is located at a predetermined distance upstream from the screw discharge end,
wherein the coolant discharge end is located within the bore and proximate to the closed terminal end of the central bore, and
further wherein the rotatable screw element comprises a plurality of screw segments, and at least one of the screw segments has a thermal conductivity that differs from the thermal conductivity of the other screw segments.

9. The extruder according to claim 8, wherein the extruder barrel comprises a plurality of barrel segments, the predetermined distance is at least the length of a barrel segment, and the last barrel segment is proximate the discharge end of the barrel.

10. The extruder according to claim 9, wherein the screw segment proximate the last barrel segment has a thermal conductivity less than the thermal conductivity of the other screw segments.

11. The extruder according to claim 10, wherein the rotatable screw element is a pair of co-rotating screw elements disposed axially within the extruder barrel.

12. The extruder according to claim 10, wherein the screw segment proximate the last barrel segment is fabricated from a ceramic material.

13. The extruder according to claim 9, wherein the last barrel segment and the screw segment proximate the last barrel segment are configured for conveying the mixture without conductive cooling from the coolant delivery conduit.

14. The extruder according to claim 8, wherein the extruder barrel comprises a plurality of barrel segments, the predetermined distance is less than the length of a barrel segment, and the last barrel segment is proximate the discharge end of the barrel.

15. The extruder according to claim 14, wherein the plurality of barrel segments is at least nine barrel segments.

16. An extruder for extruding structures from ceramic-forming mixtures, the extruder comprising:
an extruder barrel for conveying the mixture, the barrel comprising an inlet end and a discharge end;
a rotatable screw element disposed axially within the extruder barrel, the screw element comprising a screw inlet end proximate the inlet end of the barrel and a screw discharge end proximate the discharge end of the barrel;
a shaft extending axially through the screw element that comprises a central bore, the bore comprising an opening proximate to the inlet end of the extruder barrel and extending through the shaft to a closed terminal end; and
a coolant delivery conduit extending axially within the central bore comprising a coolant inlet end proximate to the inlet end of the extruder barrel and a coolant discharge end,
wherein the coolant discharge end is located within the bore and proximate to the closed terminal end of the central bore, and
further wherein the rotatable screw element comprises a plurality of screw segments, and at least one of the screw segments has a thermal conductivity that differs from the thermal conductivity of the other screw segments.

17. The extruder according to claim 16, wherein the extruder barrel comprises a plurality of barrel segments and the last barrel segment is proximate the discharge end of the barrel.

18. The extruder according to claim 17, wherein the screw segment proximate the last barrel segment has a thermal conductivity less than the thermal conductivity of the other screw segments.

19. The extruder according to claim 18, wherein the rotatable screw element is a pair of co-rotating screw elements disposed axially within the extruder barrel.

20. The extruder according to claim 18, wherein the screw segment proximate the last barrel segment is fabricated from a ceramic material.

21. (canceled)

22. (canceled)

23. (canceled)

24. (canceled)

25. (canceled)

26. (canceled)

27. (canceled)
